(19) United States
(12) Patent Application Publication
(10) Pub. No.: US 2008/0090686 A1
(43) Pub. Date: Apr. 17, 2008

(54) DISENGAGEABLE PULLEY DEVICE

(76) Inventors: Jean-Luc Gardelle, Luynes (FR); Francis Claude, Charentilly (FR); Benoit Arnault, Saint Cyr Sur Loire (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/866,299

(22) Filed: Oct. 2, 2007

(30) Foreign Application Priority Data
Oct. 4, 2006 (FR) 0654082

(51) Int. Cl. F16H 55/36; H02K 7/10

(52) U.S. Cl. 474/166; 322/41

(57) ABSTRACT

The disengageable pulley device includes a pulley mounted on an inner transmission element, and a freewheel provided with a plurality of lock-up elements mounted between a sliding track of the pulley and a sliding track of the inner transmission element. The device is provided with a cage for the lock-up elements, with at least one annular friction element provided between the cage and the sliding track of the inner transmission element to use friction to connect the cage and the said inner element, and with at least one elastic return element positioned between at least one lock-up element and the cage, the elastic return element tending to keep the lock-up elements in contact with the sliding tracks when the freewheel is in the coupled position and in the uncoupled position.

### BACKGROUND OF THE INVENTION

1. Field of the Invention

The present invention generally relates to the field of freewheels. More particularly, the present invention generally relates to the field of disengageable pulleys equipped with freewheels and used, for example, in alternator drive pulleys on motor vehicles.

2. Description of the Relevant Art

Such disengageable pulleys are known per se and are being increasingly used to overcome the detrimental effects of acyclic running or sudden engine decelerations which occur in combustion engines, particularly at low engine speeds and especially in diesel engines.

What happens is that a drive belt, which is connected to the engine by way of a crankshaft pulley, can decelerate sharply whereas a driven pulley, for example an alternator pulley, has a tendency, through inertia, to continue to turn at the same speed.

If there is a rigid coupling between the crankshaft pulley and the alternator shaft, the belt is subjected to very high stresses during these sudden variations in speed.

Such variations have detrimental effects, such as abnormal belt fatigue and the risk of breakage, slipping of the belt on the pulley, or alternatively, vibration of the strands of the belt between the pulleys.

In order to lessen these phenomena, a freewheel has been incorporated between the driven pulley and the driven shaft, allowing the pulley to be uncoupled temporarily from the shaft if the said pulley suddenly decelerates.

A disengageable pulley such as this is known, in particular, from document JP 2005-282856 and generally includes two rolling bearings one positioned on each side of the pulley, and a freewheel positioned between the two rolling bearings and provided with a plurality of lock-up cams and with a cage including a plurality of apertures for housing the said cams.

In order to limit the wear on these cams, that document envisages fixing the retaining cage to the driven shaft in order to drive the cage and the shaft at the same angular velocity. In this way, when the pulley is in the uncoupled position in which it acts as a freewheel, slipping occurs only between the cams and a sliding track situated inside the pulley, and which is correctly lubricated as a result of the centrifugal force which tends to throw the lubricant outwards.

However, with a pulley such as this, the cage has no angular degree of freedom relative to the driven shaft. The applicant company has discovered that that could be detrimental to the dependability of the freewheel, particularly by causing risks of interference between the cams and the edges of the apertures of the retaining cage as the cams pivot.

Also known, from document FR-A-2 856 759, is a disengageable pulley provided with two, coaxial, cages for retaining the lock-up cams, in which disengageable pulley the inner cage includes friction elements that come into contact with the driven shaft. The outer cage for its part includes friction elements produced in the form of clips in contact with the pulley.

In the uncoupled or freewheel position, the friction torque between the friction elements and the pulley has a tendency to slow the inner cage relative to the outer cage. The edges of apertures formed in the inner cage therefore come into contact with the lock-up cams, causing them to pivot. The cams are therefore no longer in contact with the driven shaft.

A device such as this has the disadvantage of using two retaining cages, one of which is provided with friction elements produced in the form of clips, increasing the cost price of the device.

What is more, during freewheel operation, with the cams no longer in contact with the driven shaft, the device may, in certain applications, lack the responsiveness required to switch quickly from freewheel operation to torque-transmitting operation. This is particularly the case of applications to alternators in which acyclic running results in extremely quick variations in the rotational speed of the engine.

### SUMMARY OF THE INVENTION

In the light of the above, it is therefore desirable to overcome the aforementioned disadvantages.

In an embodiment, a disengageable pulley is provided in which it is possible to switch more quickly from a freewheel position to a torque-transmitting position, and vice versa.

In an embodiment, a disengageable pulley includes components that are economical to manufacture and to assemble.

In another embodiment, a disengageable pulley is provided that is extremely dependable.

The disengageable pulley device includes a pulley mounted on an inner transmission element, and a freewheel provided with a plurality of lock-up elements, such as cams, mounted between a sliding track of the pulley and a sliding track of the inner transmission element. The said freewheel is intended to provide a one-way coupling between the pulley and the inner transmission element.

The device is provided with a cage for the lock-up elements, with at least one annular friction element provided between the cage and the sliding track of the inner transmission element to use friction to connect the cage and the inner transmission element, and with at least one elastic return element positioned between at least one lock-up element and the cage, the elastic return element tending to keep the lock-up elements in contact with the sliding tracks when the freewheel is in the coupled position and in the uncoupled position.

In other words, the elastic return element is positioned between the lock-up element and the cage which is driven by the inner transmission element, via the friction element.

Specifically, the applicant company has determined that the relative positions of the elastic return element and of the cage in particular allow there to be a tendency for permanent contact to be maintained between the sliding tracks of the device in the coupled position and in the uncoupled position. Existence of the friction element, on the one hand, and the position of the elastic return element on the cage, on the other, allows there to be a tendency for permanent slip-free contact to be maintained between the lock-up elements and the inner transmission element.

Thus, the collaboration between the elastic return element, the cage and the friction element makes it possible to increase the operational reliability of the pulley.

The annular friction element provided between the cage and the sliding track of the inner transmission element tends to cause the freewheel to be driven via the said cage at the same speed as the inner transmission element, as long as a drag torque due to the friction of the lock-up elements against the sliding track of the pulley is below the friction torque between the friction element and the component against which it is intended to rub, namely the cage or the inner transmission element.

Under these conditions, the relative slip between the sliding track formed on the inner transmission element and the lock-up elements is limited. Thus, slipping occurs essentially between the lock-up elements and the sliding track of the pulley, which is perfectly lubricated through centrifugal action. The slipping therefore generates a weak drag torque and causes minimal wear on the lock-up elements.

The frictional coupling between the cage and the inner transmission element may also allow the cage to rotate slightly with respect to the inner element, for example if the lock-up elements were to force themselves against the edges of cells or apertures as they pivot. What would happen, under such conditions, is that the lock-up elements would tend to turn the cage which can move angularly relative to the inner transmission element. This then would prevent the lock-up elements from becoming locked in position by the cage, or alternatively, would avoid damage to the said cage. That would also encourage correct operation of the freewheel.

The annular friction element is separate from the elastic return element associated with at least one of the lock-up elements.

Furthermore, the use of a friction element makes it possible to be able to provide, on the component intended to be driven, a substantially flat contact surface free of any elements that form projecting meshing teeth that require adjustment upon assembly.

Advantageously, the pulley includes a single cage for the lock-up elements. As a preference, the cage is made as one piece. The freewheel has no additional cage of a radius different from that of the cage and capable of pivoting the cams from the coupled position.

In one embodiment, the friction element is circumferentially continuous.

Advantageously, the inner transmission element tends to drive the freewheel substantially at the same speed, via the friction element and the cage.

In one embodiment, the annular friction element is mounted on the cage.

In one embodiment, at least one elastic return element is positioned between each lock-up element and the cage.

As a preference, the elastic return element is positioned radially between the cage and the inner transmission element.

In one embodiment, the freewheel includes “engaging” cams.

In one embodiment, the sliding track of the inner transmission element on which the lock-up elements can slide is formed directly from an exterior surface of the said inner transmission element.

In one embodiment, the sliding track on the pulley for the lock-up elements is formed directly by a bore in the said pulley.

The annular friction element may include a region that is elastic radially towards an exterior surface of the inner transmission element.

In one embodiment, the annular friction element is positioned on a radial portion of the cage.

In another embodiment, the annular friction element is positioned on an axial portion of the cage.

In one embodiment, the annular friction element includes a friction body and a clamping ring for the body in frictional contact. As an alternative, the annular friction element may include a friction lip supported by a radially elastic region. In another embodiment, the friction element consists of a friction body.

The friction element may be attached to the cage. The friction element is separate from the cage. It is also possible to make the function element and the cage as one piece.

In one embodiment, the device includes at least two rolling bearings, the freewheel being positioned axially between the rolling bearings.

The disengageable pulley device may be mounted on an alternator shaft with a view to driving the said alternator. The pulley may be mounted on a central shaft, particularly via a freewheel. The drive shaft may be mounted on the alternator shaft. A drive belt driven off the engine may bear against a periphery of the pulley.

By virtue of the freewheel, the pulley drives the central shaft when the engine accelerates or is at a substantially constant engine speed or alternatively is decelerating very gently. If the engine and therefore the pulley suddenly slow down, the central axis of the disengageable pulley device may continue to turn more quickly than the actual pulley thanks to the freewheel, thus safeguarding the drive belt against excessive stress.

By virtue of the embodiments described herein, the lock-up elements are tended to be kept in permanent contact with the sliding tracks when the freewheel is in the coupled position and in the uncoupled position, this in particular making it possible to switch almost instantaneously from a freewheel position to a torque-transmitting position, and vice versa. The engine also makes it possible to limit the wear on the lock-up elements which slide mainly along the outer track of the pulley which is perfectly lubricated as the device rotates.

### BRIEF DESCRIPTION OF THE DRAWINGS

The present invention will be better understood from reading the detailed description of a number of embodiments taken by way of entirely non-limiting examples and illustrated by the attached drawings, in which:

FIG. 1 is a sectioned half view of a disengageable pulley device according to a first embodiment;

FIG. 2 is a half view in axial section on II-II of FIG. 1;

FIG. 3 is a half view in axial section of a disengageable pulley device according to a second embodiment, and

FIG. 4 is a half view in axial section of a disengageable pulley device according to a third embodiment.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

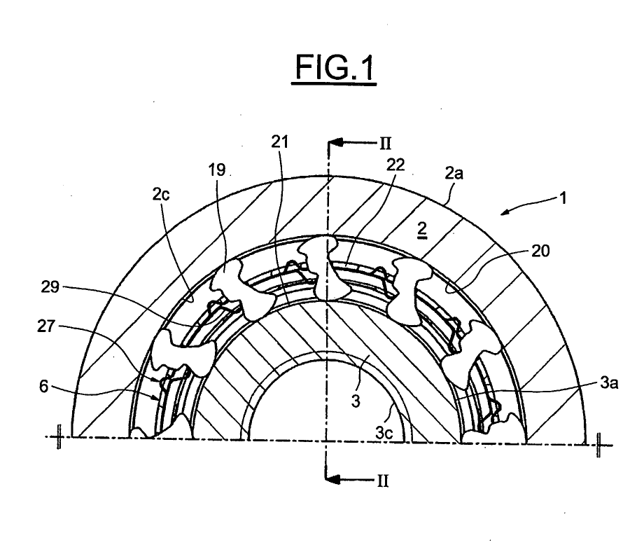

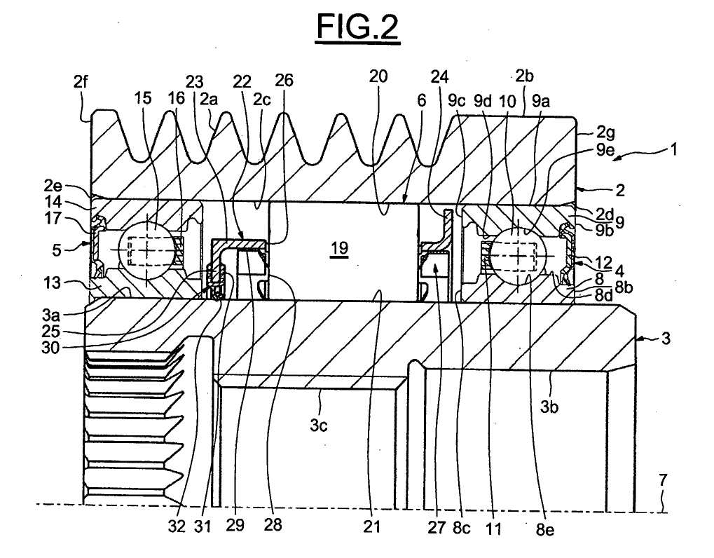

As can be seen in FIGS. 1 and 2, the disengageable pulley device 1 includes a pulley 2, an inner transmission element 3, for example a hollow shaft, two rolling bearings 4 and 5, and a freewheel 6.

The pulley 2, of axis 7, has an exterior surface provided with a grooved region 2a with annular grooves and an axial region 2b formed at an axial end of the grooved region 2a. The pulley 2 includes a cylindrical bore 2c extending the entire length of the pulley 2, except for chamfers 2d and 2e positioned one at each axial end, and two radial transverse surfaces 2f and 2g.

The inner transmission element 3, which is in the form of a hollow shaft, has a cylindrical axial exterior surface 3a on which there is a chamfer (not referenced) at each of the axial ends. The inner transmission element 3 also has a bore 3b, part 3c of which has a screw thread so that an alternator shaft can be fixed to this end and driven (this is not depicted).

The rolling bearing 4, coaxial with the axis 7, includes an inner ring 8, an outer ring 9, between which there are housed a row of rolling elements 10, here produced in the form of balls, a cage 11 for maintaining the circumferential spacing of the rolling elements 10, and a seal 12.

The inner ring 8 includes a bore 8a of cylindrical shape, pushed onto the exterior surface 3a of the inner transmission element 3 and delimited by two opposed radial lateral surfaces 8b and 8c, and a stepped exterior cylindrical surface 8d from which a circular groove 8e is formed, this circular groove having, in cross section, a concave internal profile able to form a raceway for the rolling elements 10, the said circular groove being directed outwards.

The outer ring 9 includes an exterior cylindrical surface 9a pushed into the bore 2c of the pulley 2 and delimited by transverse surfaces 9b and 9c, and a stepped bore 9d of cylindrical shape from which a circular groove 9e is formed, this circular groove having, in cross section, a concave internal profile able to form a raceway for the rolling elements 10 and directed inwards. The bore 9d here includes two annular grooves (not depicted), which are mutually symmetric with respect to a plane passing through the centre of the rolling elements 10. Inside the annular groove situated on the outer side of the bearing 4 is the seal 12 which rubs against the cylindrical exterior surface 8d of the inner ring 8 in order to achieve sealing. The seal 12 is positioned radially between the inner and outer rings 8, 9 and is mounted axially between the rolling elements 10 and the radial surfaces 8b and 9b of the rings 8 and 9. The said surfaces lie axially flush with the radial transverse surface 2g of the pulley 2.

Similarly, the bearing 5, coaxial with the axis 7, includes an inner ring 13 pushed onto the exterior surface 3a of the inner transmission element 3, an outer ring 14 pushed into the bore 2c of the pulley 2, and between which rings there are housed a row of rolling elements 15, here produced in the form of balls, a cage 16 for maintaining the circumferential spacing of the rolling elements 15, and a metal seal 17. The bearing 5 is identical to the bearing 4 and is positioned symmetrically with respect to the latter with regard to a radial plane passing through the centre of the pulley 2. The bearing 5 thus axially lies flush with the radial transverse surface 2f of the pulley 2.

The bearings 4 and 5 are therefore positioned one at each axial end of the pulley 2, the freewheel 6 being mounted axially between them. The freewheel 6 thus enjoys protection against the ingress of foreign bodies the bearings 4 and 5 and particularly from the seals 12 and 17.

The freewheel 6 includes a plurality of lock-up elements or cams 19 positioned between two sliding tracks 20 and 21, the shapes of which are cylinders of revolution. The cams 19 are of the “engaging” type, that is to say of the type which, under the effect of the centrifugal forces that appear as the freewheel rotates, tend to pivot in the direction that encourages them to become locked between the two sliding tracks 20 and 21, to make it easier to switch almost instantaneously from freewheel operation to torque-transmitting operation.

The sliding track 20 is formed of the bore 2c of the pulley 2. The sliding track 21 is formed by the axial exterior surface 3a of the shaft 3.

In other words, the pulley 2 can be manufactured with an interior surface of a particularly simple shape that is entirely axial with the exception of the end chamfers 2d and 2e. The pulley 2 can therefore be obtained for a low cost price. This interior surface constitutes an exterior bearing surface for the cams 19, or large-diameter bearing surface.

On the opposite side, the sliding track 21 is formed on the exterior surface 3a of the shaft 3. The exterior profile of revolution of the shaft 3 has the same diameter over its entire length. Finishing can be performed in a single operation on a grinding machine and allows the small-diameter sliding track 21, or interior bearing surface, for the cams 19 of the freewheel 6 to be mass-produced at low cost.

The freewheel 6 also includes a cage 22 of annular overall shape that can be made of a metallic material, particularly of steel, or alternatively can be made from a synthetic material such as polyamide.

The cage 22 includes an axial portion 23 of two radial portions 24, 25. The radial portion 24 is a radially outwards extension of an axial end of the portion 23 situated near the bearing 4, while the radial portion 25 is a radially inwards extension of an axial end of the portion 23 situated near the bearing 5. The free ends of the radial portions 24 and 25 are located near the bore 2c of the pulley 2 and near the exterior surface 3a of the inner transmission element 3, respectively. In other words, the radial portion 24 remains distant from the bore 2c, the radial portion 25 for its part remaining distant from the exterior surface 3a.

The cage 22 also includes a plurality of apertures 26 formed in the axial portion 23 and forming a housing for the cams 19. The apertures 26 are uniformly spaced apart in the circumferential direction. The cage 22 keeps the cams 19 at a uniform circumferential spacing.

The freewheel 6 further includes a spring 27 which is made in the form of an annular metal band wound on itself and connected end to end or with partial overlap. The spring 27 is mounted inside the cage 22, and more specifically is positioned radially between the exterior surface 3a of the transmission element 3 and the axial portion 23 of the cage 22. The spring 27 is situated axially between the radial portions 24 and 25 of the cage 22.

The spring 27 also includes cells or apertures 28 which correspond to those of the cage 22 so that the cams 19 can be fitted. Hence, the apertures 28 are uniformly circumferentially spaced.

The spring 27 is also provided with at least one elastic return element 29 per cam 19 and produced in the form of a tab designed to press against a purpose-made surface of the associated cam 19 so as to exert a pivoting torque that tends to keep the cams 19 in contact with the sliding tracks 20 and 21. In a static position, the return elements 29 exert a force directed towards the pulley 2.

As an alternative, an individual return element associated with each cam exerts a force tending to maintain constant contact with the sliding tracks 20 and 21. It is, for example, possible to mount, for each of the cams 19, an elastic return spring positioned between the cam 19 and the cage 22.

In order to connect the cage 22 and the inner transmission element 3 using friction, the freewheel 6 also includes an annular friction element 30 positioned between the cage 22 and the exterior surface 3a of the inner element 3. The friction element 30 here is attached to the cage 22, but as an alternative, a friction element 30 is mounted on the exterior surface 3a of the inner transmission element 3.

The annular friction element 30 includes a friction body 31 and an elastic clamping ring 32 for the body, surrounding a portion of the body in frictional contact with the inner transmission element 3.

The annular friction body 31 is made of a synthetic material, for example of an elastomer. It is provided with a radial portion (not referenced) fixed to the free end of the radial portion 25 of the cage 22, with a first oblique portion (not referenced) extending the radial portion inwards towards the transmission element 3 and cams 19, and with a second oblique portion (not referenced) extending a small-diameter edge of the first oblique portion outwards. An interior surface of the region where the first and second oblique portions meet comes into frictional contact with the exterior surface 3a of the transmission element 3. The friction body 31 may advantageously be overmoulded directly onto the radial portion 25 of the cage 22 so as to obtain a one-piece entity, and has a high coefficient of friction so that the transmission element 3 can be rotationally driven.

The elastic clamping ring 32 is made of a metallic material. It is mounted to bear against an exterior surface of the said region where the first and second oblique portions meet. It forms a spring and is able radially to pre-load the friction body 31 against the exterior surface 3a of the inner transmission element 3, so as to keep these two elements in contact with one another and compensate for wear.

The way in which the freewheel 6 works is as follows: at a steady engine speed or when the pulley 2 is accelerating, the cams 19 have a tendency, under the effect of centrifugal forces and through contact with the sliding tracks 20 and 21, to pivot in a first direction which allows them, by bracing between the two sliding tracks, to become locked together with the two sliding tracks 20 and 21 belonging to the pulley 2 and to the inner transmission element 3. The freewheel 6 operates in torque-transmitting or coupled mode and transmits a driving torque between the pulley 2 and the inner element 3.

By contrast, when the pulley 2 decelerates rapidly, the cams 19 have a tendency to pivot in a second direction, the opposite to the first, causing the cams 19 to unlock or become free. The freewheel 6 then no longer transmits any torque and temporarily allows a relative rotational movement of the pulley 2 with respect to the inner transmission element 3. The freewheel 6 thus provides a one-way coupling between the pulley 2 and the transmission element 3.

In this uncoupled position, the elastic return elements 29 positioned between the single cage 22 and the cams 19 have a tendency to maintain sliding contact between the perfectly lubricated sliding track 20 belonging to the pulley 2 and the said cams 19. During the transient phase between the switch from the coupled position to the uncoupled position, or vice versa, the applicant company has determined that the relative arrangement of the elastic return elements 29 and of the cage 22 allows contact between the cams 19 and the sliding tracks 20, 21 to be effectively maintained.

In the uncoupled position, the annular friction element 30 provided between the cage 22 and the sliding track 21 of the inner transmission element 3 tends through friction to drive the rotation of the freewheel 6 via the said cage at the same speed as the inner transmission element 3. Thus, the inner transmission element 3 and the cage 22 rotate as one and any relative slip between the sliding track 21 formed on the inner transmission element 3 and the cams 19 is thus eliminated or limited. The cams 19 and the inner transmission element 3 are in contact, but with little or no relative slip.

This rotational drive works as long as a drag torque due to the friction of the cams 19 against the sliding track 20 of the pulley 2 is lower than the friction torque between the friction element 30 and the exterior surface 3a of the inner transmission element 3. In this case, there is then slipping with contact between the cams 19 and the sliding track 21. In the event of any possible wear of the friction body 31 through friction with the said exterior surface 3a, the elastic clamping ring 32 deforms the region where the oblique portions meet radially inwards so as to maintain frictional contact between the element 30 and the inner transmission element 3. In other words, the clamping ring 32 makes it possible to obtain a friction element which compensates for wear.

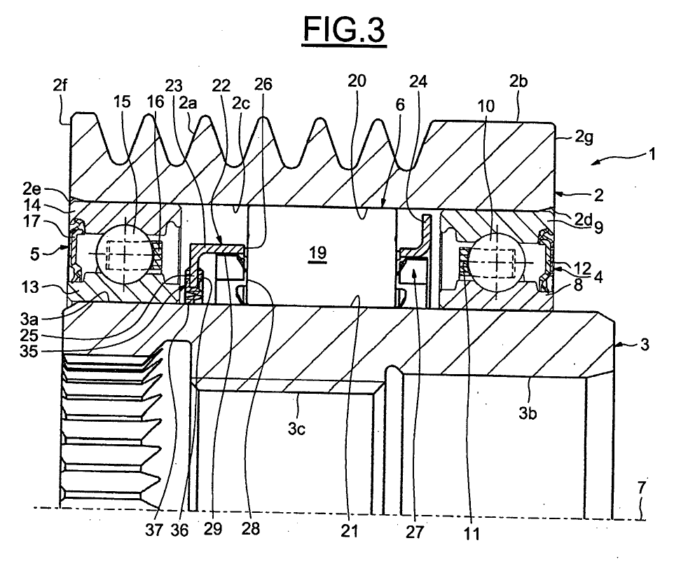

The embodiment illustrated in FIG. 3 differs in that the freewheel 6 is provided with an annular friction element 35 including a body 36 provided with a radially elastic region and with a lip 37 in frictional contact with the inner transmission element 3. The friction element 35, made as a single piece, is made of a synthetic material, for example of a polyamide or of an elastomer.

The radially elastic region here includes a first annular axial portion (not referenced) fixed to the radial portion 25 of the cage 22, which is extended inwards by a first oblique portion extending inwards towards the spring 27, itself extended to a small-diameter edge by a second oblique portion extending inwards towards the bearing 5.

The body 36 thus forms a broken line with alternating re-entrant and salient corners, offering a great deal of radial elasticity and compensating for any wear of the lip 37 in operation. The said lip 37 is connected to the second oblique portion of the body 36. The lip 37 extends axially along the exterior surface 3a of the inner transmission element 3 and is in frictional contact with the said surface. It has a high coefficient of friction so that the transmission element 3 can be rotationally driven. The lip 37 is in frictional contact with the said exterior surface 3a.

In this embodiment, the cage 22 may be made of a metallic material, particularly of steel, or alternatively from a synthetic material such as a polyamide. As an alternative, the housing cage 22 and the friction element 35 are formed as one and produced by moulding a synthetic material such as a polyamide, particularly Nylon-4,6.

In another alternative form of embodiment, a friction element 35 is mounted on the exterior surface 3a of the inner transmission element 3 and comes into frictional contact with the cage 22.

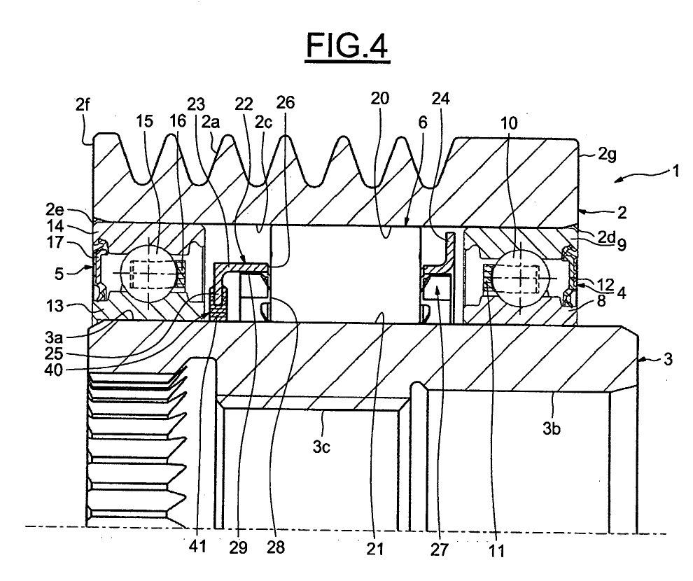

The embodiment illustrated in FIG. 4 differs in that the freewheel 6 is provided with an annular function element 40 consisting of a body 41. The body 41 is advantageously made of a synthetic material, for example of a polyamide, and overmoulded onto the radial portion 25 of the cage 22. The body 41, of annular overall shape, includes a bore in frictional contact with the exterior surface 3a of the transmission element 3. It has a high coefficient of friction so that the transmission element 3 can be rotationally driven. As an alternative, a friction element 40 is mounted on the exterior surface 3a of the inner transmission element 3 and comes into frictional contact with the cage 22.

In an application to an alternator drive pulley for a motor vehicle, thanks to the freewheel, the pulley drives the central shaft when the engine is accelerating or is at a substantially constant engine speed, or alternatively is decelerating very gently. If the engine and therefore the pulley suddenly decelerate, the central axis of the disengageable pulley device may continue to turn more quickly than the actual pulley by virtue of the freewheel, thus preserving the drive belt from excessive stress. Furthermore, the freewheel allows a practically instantaneous switch from freewheel operation to torque-transmitting operation, and is very reliable over time.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A disengageable pulley device comprising:
a pulley mounted on an inner transmission element;
a freewheel provided with a plurality of lock-up elements mounted between a sliding track of the pulley and a sliding track of the inner transmission element, the said freewheel being intended to provide a one-way coupling between the pulley and the inner transmission element;
a cage for the lock-up elements;
at least one annular friction element provided between the cage and the sliding track of the inner transmission element to use friction to connect the cage and the said inner element, and;
at least one elastic return element positioned between at least one lock-up element and the cage, the elastic return element tending to keep the lock-up elements in contact with the sliding tracks when the freewheel is in the coupled position and in the uncoupled position.

2. Device according to claim 1, wherein the cage is single cage for the lock-up elements.

3. Device according to claim 1, in which, in an uncoupled position, the inner transmission element tends to drive the freewheel substantially at the same speed, via the friction element and the cage.

4. Device according to claim 1, in which the annular friction element is mounted on the cage.

5. Device according to claim 1, wherein at least one elastic return element is positioned between each lock-up element and the cage.

6. Device according to claim 1, in which the elastic return element is positioned radially between the cage and the inner transmission element.

7. Device according to claim 1, in which the annular friction element is positioned on a radial portion of the cage.

8. Device according to claim 1, in which the friction element comprises a region that is elastic radially towards an exterior surface of the inner transmission element.

9. Device according to claim 1, in which the friction element comprises a friction body and a clamping ring for the body in frictional contact.

10. Device according to claim 1, in which the annular friction element comprises a friction lip supported by a radially elastic region.

11. Device according to claim 1, in which the friction element consists of a friction body.

12. Alternator comprising a shaft and a disengageable pulley device according to claim 1, mounted on the said shaft.
